(19) United States
(12) Patent Application Publication
(10) Pub. No.: US 2011/0246778 A1
(43) Pub. Date: Oct. 6, 2011

(54) PROVIDING SECURITY MECHANISMS FOR VIRTUAL MACHINE IMAGES

(75) Inventor: WILLIAM M. DUANE, Westford, MA (US)

(73) Assignee: EMC CORPORATION, Hopkinton, MA (US)

(21) Appl. No.: 12/751,577

(22) Filed: Mar. 31, 2010

(51) Int. Cl. H04L 9/32

(52) U.S. Cl. 713/176; 713/168

(57) ABSTRACT

A method for providing a security mechanism for validating and executing a virtual machine image where the virtual machine image is obtained from an external source to run on an endpoint or host system. An electronic device storing validation data is connected to the host system, and the virtual machine image is validated with the validation data. The virtual machine image run on the host system if validated and/or decrypted. The electronic device can be a USB flash drive, and the electronic device can include a security processor with memory in addition to having a display, keypad, token, or any combination thereof. The validation data utilized may comprise a keyed hash or digital signature when validating the virtual machine image.

### BACKGROUND

### Description of Related Art

Virtualization is becoming more prevalent in the information technology industry, transforming computational functionality into information that can be stored and managed. Virtual machines (“VMs”) may allow for the running of multiple operating systems on one physical machine. Users of VMs may want to save the state of a virtual machine, or to take a snapshot (or multiple snapshots) of a VM in order to preserve a virtual machine state (and perhaps, later in time, to get back to that state). Such VM images are used by endpoint systems in a virtual environment where the virtual machine image and the endpoint user require validation as part of a security mechanism for the VM image to run without tampering.

### SUMMARY OF THE INVENTION

A method for use in providing a security mechanism for validating and executing a virtual machine image, the method comprising the steps of: obtaining the virtual machine image from an external source to run on a host system; connecting an electronic device comprising of validation data to the host system; validating the virtual machine image with the validation data; indicating whether the validation matched; and running the virtual machine image on the host system if authenticated.

Additional embodiments consistent with principles of the invention are set forth in the detailed description that follows or may be learned by practice of methods or use of systems or articles of manufacture disclosed herein. It is understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention. In the drawings:

FIG. 1 is a flow diagram representing the logical steps of providing the security mechanism for VM images.

FIG. 2 is a block diagram representing a computer system environment in which the invention will operate.

FIG. 3 is a block diagram representing an example embodiment of the invention where the electronic device is a flash memory device.

FIG. 4 is a block diagram representing an example embodiment of the invention where the electronic device comprises a security processor with additional memory.

FIG. 5 is a block diagram representing an example embodiment of the invention where the electronic device comprises combinations of the following: a security processor; a memory; a display, a keypad and a token.

### DETAILED DESCRIPTION OF EMBODIMENT(S)

Traditional security mechanisms based on unique computer hardware identifiers fail in the virtual environment. The unique computer hardware identifiers used for key generation, storage, authentication, or system fingerprinting conventionally fall short where multiple VM images are created with the same underlying physical hardware. Conventionally, VM images may be presented with an abstracted or generalized view of the hardware, thus eliminating the possibility of creating unique imprints amongst them. Virtual endpoint systems consequently lose fundamental underpinnings, once created traditionally by hardware roots of trust. Hence, a secure method is needed to carry and validate the VM image for the end user.

An embodiment of an example of the invention leverages the use of an Universal Serial Bus, or USB, device that can contain keys needed to authenticate/decrypt a downloaded VM image, thus allowing the image to be encrypted and or/digitally signed to assure integrity in transmission and during usage in the endpoint system. The device may contain significant flash memory to carry an encrypted image, and act as a bootable USB device at the desired endpoint or host system to decrypt and validate the VM image. In addition, the device can generate and store keys needed by the virtual endpoint systems to operate. Presence of the device may be needed to start the virtual endpoint system, and removal of the device renders the endpoint system inoperative. The device may also store volatile impure data between VM image boots. As a result, the device can act as the root of trust enabling VM images to run on the endpoint system while providing privacy, access control, and personalization.

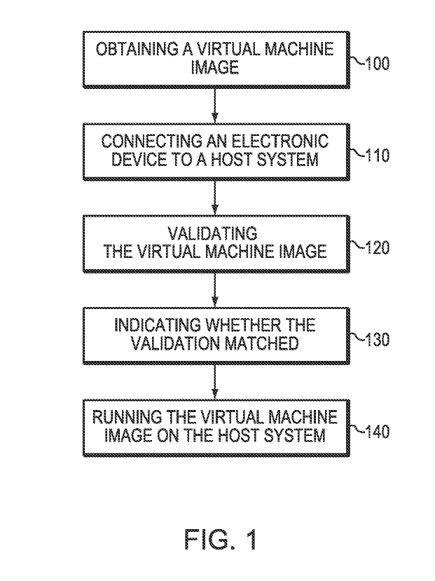

FIG. 1 illustrates an embodiment of an example implementation of the invention. One such embodiment comprises the host system or the endpoint system obtaining the VM image 100 from an issuing authority by one or more of the following methods: downloading over a network; or copying the virtual machine image from a computer readable storage medium such as a flash memory drive, a CD-ROM, or a DVD-ROM. The downloading medium may be any one or more of a variety of networks or other type of communication connections as known to those skilled in the art. For example, the network may include one or more of the following: a global computer network such as the Internet, a wide area network (WAN), a local area network (LAN), a satellite network, a telephone or cable network, a wireless link such as 802.11 and/or Bluetooth, a USB based link, a serial or parallel link, a processor interface link, a memory interface link, or various portions or combinations of these and other types of links. An electronic device that contains data (e.g., cryptographic validation data) used for validating the VM image is then connected to a host system (e.g., a personal computer) 110. For instance, the electronic device can be a USB device that is inserted into the host system's USB port directly. The integrity of the virtual machine image is then verified by various validation methods 120 that verify whether the VM image has been tampered with or modified and whether the VM image is authentic—meaning, whether the VM image has been issued by the proper authority. One example aspect of the validation process comprises a VM image that is hashed using a cryptographic hash algorithm. The host system maintains validation software that rehashes the VM image and compares the resulting hash with that which was stored previously in the electronic device. Matching hash values show that the VM image has not been tampered with or modified.

Another example aspect of the validation process uses the cryptographic hash function described above in combination with a key on the VM image (e.g., Hash-based Message Authentication Code or HMAC or keyed hash), wherein the electronic device stores the hash value and the key. The validation software rehashes the VM image using the key stored in the electronic device, and verifies whether the output matches to the hash value stored on the electronic device. If there is a match, the VM image has not been tampered with or modified and the VM image is authentic. This process can be further enhanced as to comprise unique keys for different end users to allow for additional assurance of authenticity.

Yet another example aspect of the validation process includes the use of a digital signature. The VM image can be digitally signed by the issuing authority, and the electronic device can contain the digital signature of the VM image in which case the validation software in the host system contains the digital certificate matching the key used to sign the VM image. This process can further comprise encryption of the VM image using the digital certificate of the end user. The end user's private key can then be used to decrypt the VM image allowing for more personalization and privacy. Here, the electronic device can also store the end user's digital certificate for use by the issuing authority as a prerequisite to perform the initial encryption. As the end user connects the end user's device to obtain the encrypted VM image, the issuing authority can read the device to get the end user's digital certificate prior to the initial encryption. Another modification of the above mentioned process can involve the issuing authority to encrypt the VM image using its own private key. The electronic device can contain the digital certificate of the issuing authority, and the validation software may decrypt the VM image using the digital certificate stored on the device. Yet another modification of the process can be the issuing authority encrypting the VM image using a symmetric encryption key where the validation software can decrypt the VM image using the encryption key stored on the electronic device. The decryption in these processes can occur in the validation software or in the electronic device, and the electronic device can contain both the digital certificate and the signature. Matching signatures indicate that the VM image has not been tampered with or modified and that VM image is authentic.

Upon the completion of the validation process, the validation software indicates whether the validation passed or failed 130. If there is a match, the validation passed and the VM image is authentic or has not been tampered with and the host system executes the VM image 140.

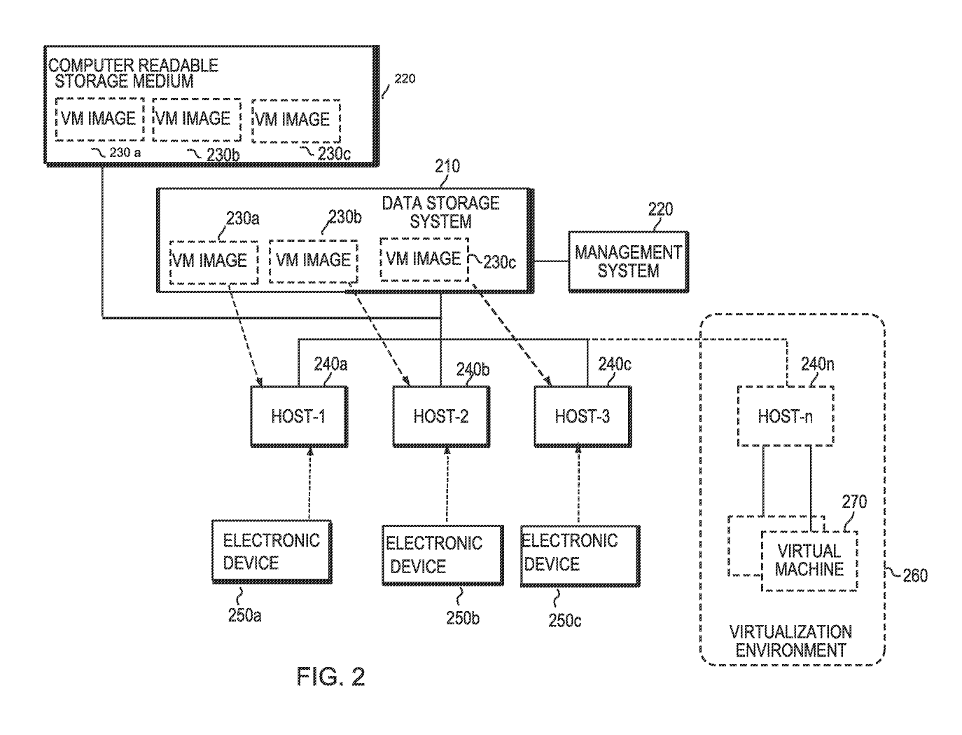

FIG. 2 is an illustration of an example of an environment in which the invention may be implemented. VM images 230a-c can be obtained by downloading from an issuing authority, for example, a type of data storage system 210 managed by a management system 220. A computer readable storage medium can also be used to transfer the VM images 230a-c to the various host systems 240a-n. In order to run a VM image on a host system, an end user may require a specific electronic device capable of validating and/or decrypting the VM image. For example, validation data stored in electronic device 250a can be specifically required for VM image 230a to run on host system 240a.

At least one of the host systems 240a-n includes or provides one or more virtual machines 270 which may correspond to the underlying host system 240n. The context of an example to which the invention may be implemented is within a virtualization system or environment 260. Virtualization environment 260 is representative of a wide variety of designs and implementations in which underlying hardware resources are presented to software (typically to operating system software and/or applications) as virtualized instances of computational systems that may or may not precisely correspond to the underlying physical hardware. The processors included in the host systems 240a-n and may be any one of a variety of proprietary or commercially available single or multi-processor system, such as an Intel-based processor, or other type of commercially available processor able to support traffic in accordance with each particular embodiment and application.

Host systems 240a-n provide data and access control information through channels to the storage systems, and the storage systems may also provide data to the host systems also through the channels. The host systems do not address the disk drives of the storage systems directly, but rather access to data may be provided to one or more host systems from what the host systems view as a plurality of logical devices or logical volumes. The logical volumes may or may not correspond to the actual disk drives. For example, one or more logical volumes may reside on a single physical disk drive. Data in a single storage system may be accessed by multiple hosts allowing the hosts to share the data residing therein. A LUN (logical unit number) may be used to refer to one of the foregoing logically defined devices or volumes.

With respect to virtualization systems, the term virtualization system as used herein refers to any one of an individual computer system with virtual machine management functionality, a virtual machine host, an aggregation of an individual computer system with virtual machine management functionality and one or more virtual machine hosts communicatively coupled with the individual computer system, etc. Examples of virtualization systems include commercial implementations, such as, for example and without limitation, VMware® ESX Server™ (VMware and ESX Server are trademarks of VMware, Inc.), VMware® Server, and VMware® Workstation, available from VMware, Inc., Palo Alto, Calif.; operating systems with virtualization support, such as Microsoft® Virtual Server 2005; and open-source implementations such as, for example and without limitation, available from XenSource, Inc.

As is well known in the field of computer science, a virtual machine is a software abstraction—a “virtualization”—of an actual physical computer system. Some interface is generally provided between the guest software within a VM and the various hardware components and devices in the underlying hardware platform. This interface-which can generally be termed “virtualization layer”—may include one or more software components and/or layers, possibly including one or more of the software components known in the field of virtual machine technology as “virtual machine monitors” (VMMs), “hypervisors,” or virtualization “kernels.”

Because virtualization terminology has evolved over time, these terms (when used in the art) do not always provide clear distinctions between the software layers and components to which they refer. For example, the term “hypervisor” is often used to describe both a VMM and a kernel together, either as separate but cooperating components or with one or more VMMs incorporated wholly or partially into the kernel itself. However, the term “hypervisor” is sometimes used instead to mean some variant of a VMM alone, which interfaces with some other software layer(s) or component(s) to support the virtualization. Moreover, in some systems, some virtualization code is included in at least one “superior” VM to facilitate the operations of other VMs. Furthermore, specific software support for VMs is sometimes included in the host OS itself.

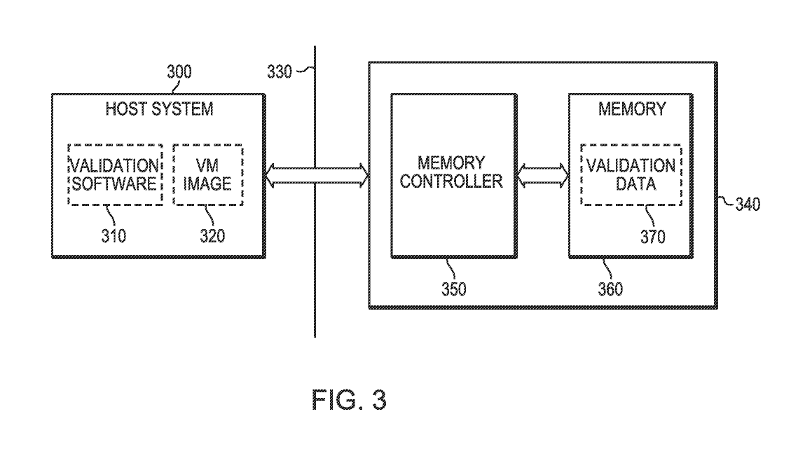

FIG. 3 illustrates a block diagram of a system used during the validation process between a host system 300 and an electronic device, which here, is an USB flash memory device 340. The USB flash memory device 340 has the functionality of a typical mass storage device, e.g., stores and recalls files. The host system 300, which in this case can be a personal computer, communicates with flash memory drive 340 via USB interface 110. Hardware drivers that enable communication between the endpoint system 300 and flash memory drive 340 via USB interface 330 are part of the normal functionality of the endpoint system 300. Flash memory device 340 incorporates memory controller 350, which receives, understands, and implements the file I/O commands that host system 300 transmits. These commands are part of the typical functionality of a memory controller, and include “read file” and “write file.” The flash memory device 340 contains validation data 370 which can be one or more of the following: a hash value; a keyed hash value; a digital signature; certificate corresponding to the digital signature; or any combination thereof. Host system 300 may download the VM image 320, or obtain a copy of the VM image from a computer readable storage medium. Specifically, with sufficient memory 360, the VM image 320 can be copied or transferred from the flash memory device 340—meaning, the VM image 320 can initially be stored in the flash memory device 340. This allows the user to initially install or “charge” the VM image 320 along with the validation data 370 on the device 340 allowing greater portability without dependence on an external source prior to usage on an endpoint system. The validation software 310 validates the VM image 320. The validation software 310 can also be in the device 340 that may allow the software run directly off the device 340 and that may allow the software to auto-run when the device 340 connects to the host system 300. When inserted, the validation software 310 can automatically run and check the validity of the image, and ultimately, start the VM image 320.

The device 340 may also include an end user certificate at the start. When being “charged,” the VM image can be encrypted using the key of the end user. This way, only the valid end user may decrypt and run the VM image. The key can be maintained on the device or loaded into the validation software, which may need to perform the decryption as part of its function.

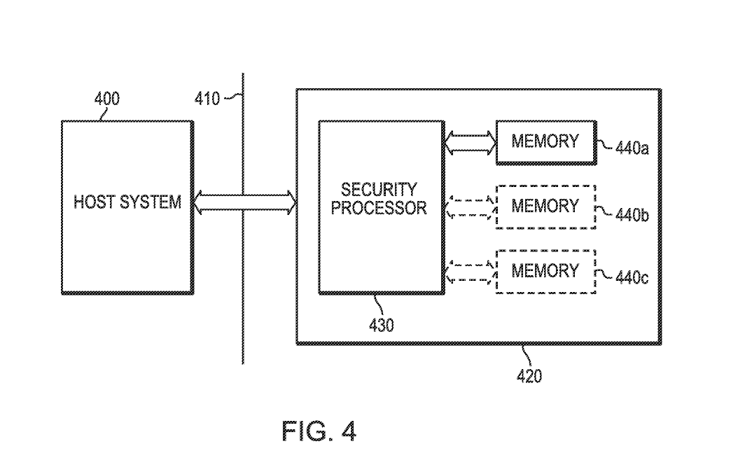

FIG. 4 illustrates yet another embodiment of an example of the claimed invention. In this embodiment, the electronic device 420, which is otherwise the same as device 340 described above, has additional flash memory device capability by including a security processor 420. Other aspects are similar to what has been already discussed including the host system 400 communicating with the electronic device 420 containing one or more memory chips 440a-c via an USB interface 410. With this embodiment, the user of the host system may be required to enter a pin or passphrase into the validation software 310 which is then passed to the device for verification. If the pin or passphrase is correct, the device unlocks and allows the validation process to proceed (e.g., FIG. 1). The validation software may perform initial cryptographic operations on the VM images (e.g., hashing) and pass the data to the security processor 430 for final validation. The device may then pass the results of the validation back to the validation software to signal the user. The original cryptographic validation keys can be stored in the secure memory of the security processor. In the case where more memory 440a-c is added, the same principles of FIG. 3 or any combinations thereof are possible (e.g., storing and running the validation software and/or the VM image on the device). Accordingly, the core cryptographic function may run on the security processor 430 instead of the validation software where the possibility of hacking is greater. Also, the device can act as an ignition key in that the VM image may check for the presence of the device at VM image startup, and if the device is not present the VM image may refuse to start. Additionally, under policy control, the VM image may shut down or log users off if the device 420 is removed from the connection port 410.

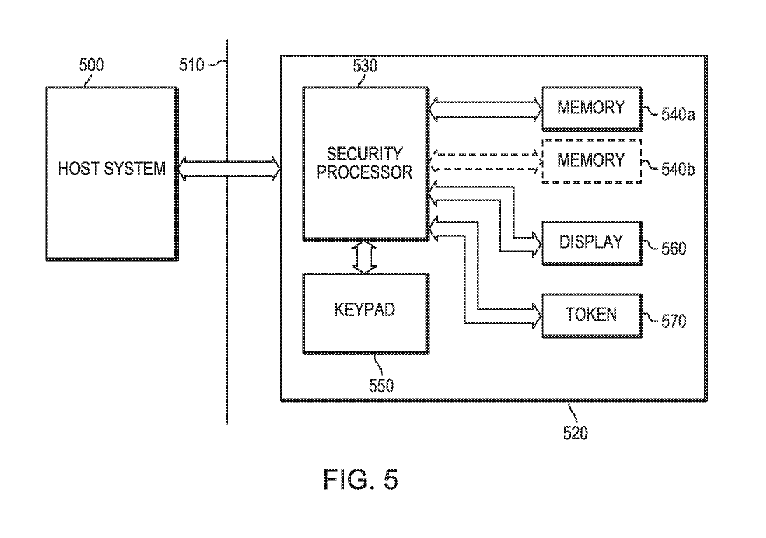

FIG. 5 is yet another aspect of an example of the claimed invention. The electronic device 520, which is otherwise the same as device 340 and 420 described above, may also have a display 560 to indicate status and information of the device to the user. The display 560 may comprise one or more of the following: a simple LED used as a go/no go indicator; a display of one or more text lines; or a graphics display (e.g., an OLED display). The device 520 can also include a keypad 550 to allow user input. For example, if the electronic device 520 is holding multiple VM images in its memory 540a-b, this allows some management of operations by allowing the user to select between the VM images stored. The device 520 can also include a token 570 that generates passcodes (e.g., one time passcodes or OTPs). OTPs are passwords that authenticate a user to a host only a single time, enabling access to a computing resource only once per password. An OTP token typically generates a series of passcodes, for example, one new passcode every minute. The token does this with an algorithm that takes as input some data which varies (e.g., the current time on the token's internal clock, and a “seed” value which is programmed into the token at the time of manufacture. The token may then display the resulting output, OTP, on a display. The display can be on the face of the token itself or display 560 can be utilized for this purpose as well. The token can function without a display by directly communicating with the host 500. One such example of authentication tokens is the RSA SecurID authentication token commercially available from RSA Security Inc. of Bedford, Mass., U.S.A. If the device 520 directly can connect back to a trusted site, it can act as a trusted location to fetch the VM images, cryptographic validations, and the like in real time rather than requiring the device to obtain them in advance. Also, the device can be configured to have a storage area to hold updated information which may be necessary as all impure data are generally lost upon reboot. The device 520 can also hold some policy or configuration information to be used by the VM image once it starts. The device 520 can obtain and store account information such as user names and passwords. The device 520 can also hold logs of events relevant to the running and security of the VM image which can be read the next time the user parks the device 520 into a host 500. The device may also be configured to act as a yet another authentication server for the VM image where, for example, the VM image may pass login information to the device for validation.

What is claimed is:

1. A method for use in providing a security mechanism for validating and executing a virtual machine image, the method comprising the steps of:
obtaining the virtual machine image from an external source to run on a host system;
connecting an electronic device comprising of validation data to the host system;
validating the virtual machine image with the validation data;
indicating whether the validation matched; and
running the virtual machine image on the host system if authenticated.

2. The method of claim 1, wherein the virtual machine image is obtained via one or more of a network and a computer readable medium.

3. The method of claim 1, wherein the validation data comprise one or more of hash, a keyed hash, or a digital signature.

4. The method of claim 1, wherein validating refers to verifying whether the virtual machine image has been tampered with or modified.

5. The method of claim 1, wherein validating refers to authenticating the source of the virtual machine image.

6. The method of claim 1, the electronic device further comprising of one or more of a security processor and at least one memory.

7. The method of claim 1, the validation data comprising one or more of a keyed hash and digital signature.

8. The method of claim 6, further comprising one or more of a keyed hash and digital signature which are loaded on the electronic device.

9. The method of claim 1, further comprising of a validation software wherein the validation software validates the virtual machine image.

10. A method for use in providing a security mechanism for validating and executing a virtual machine image, the method comprising the steps of:
obtaining the virtual machine image from an external source to run on a host system wherein the virtual machine image is obtained via one or more of a network and a computer readable medium;
connecting an electronic device comprising of validation data to the host system;
validating the virtual machine image wherein the validation data comprise one or more a keyed hash and a digital signature;
indicating whether the validation matched; and
running the virtual machine image on the host system if authenticated.

11. The method of claim 10, further comprising the step of authenticating an end user prior to validating the virtual machine image.

12. The method of claim 10, further comprising the step of authenticating an end user prior to validating the virtual machine image, wherein the end user is authenticated via an end user validation data stored in the electronic device.

13. The method of claim 10, further comprising of a validation software wherein the software validates the virtual machine image.

14. The method of claim 10, the electronic device further comprising of one or more of a security processor and at least one memory.

15. The method of claim 10, wherein the electronic device has a display indicating status and information to the end user.

16. The method of claim 10, wherein the electronic device has a keypad allowing end user input.

17. A system for use in providing a security mechanism for validating and executing a virtual machine image, the system comprising of:
a virtual machine server including a plurality of virtual machines and a database;
a data storage system being in communication with the virtual machine server; and
computer executable program logic executable at the virtual machine server for providing a plurality of different virtual computing environment; and
an endpoint system that which communicates with an electronic device thereby providing for a security mechanism by following the steps of:
obtaining the virtual machine image from an external source to run on a host system wherein the virtual machine image is obtained via one or more of a network and a computer readable medium;
connecting an electronic device comprising of validation data to the host system;
validating the virtual machine image wherein the validation data comprise one or more a keyed hash and a digital signature;
indicating whether the validation matched; and
running the virtual machine image on the host system if authenticated.

18. The system of claim 17, the electronic device further comprising of one or more of a security processor and at least one memory, wherein validation data are stored on the electronic device.

19. The system of claim 17, further comprising of a validation software wherein the validation software validates the virtual machine image.

20. The system of claim 17, wherein the virtual machine server refers to the host systems.
